(19) United States
(12) Patent Application Publication
(10) Pub. No.: US 2015/0118662 A1
(43) Pub. Date: Apr. 30, 2015

(54) Process to promote healthy behaviors through motivation using mobile messaging and geofencing technologies

(71) Applicants: Brian Ellison, Fleming Island, FL (US); Richard M. Graf, Jacksonville, FL (US); Elizabeth N. Pierce, Jacksonville, FL (US); Angel D. Cabrera, Jacksonville, FL (US)

(72) Inventors: Brian Ellison, Fleming Island, FL (US); Richard M. Graf, Jacksonville, FL (US); Elizabeth N. Pierce, Jacksonville, FL (US); Angel D. Cabrera, Jacksonville, FL (US)

(21) Appl. No.: 14/064,993

(22) Filed: Oct. 28, 2013

(51) Int. Cl. G09B 19/00; H04W 4/12; H04W 4/02

(52) U.S. Cl. CPC G09B 19/00; H04W 4/021; H04W 4/12
USPC 434/236

(57) ABSTRACT

Provided is a mobile health and wellness motivational system in which users specify times and/or locations where they know they will need help with lifestyle challenges. Using the smartphone's clock and geo-fencing technologies, a motivational message arrives at the specified time and/or location. Highly personalized, this system provides motivation in the form of text, photo, video, music or launched text or call; using inspiration, deterrent, tips or distraction at the specified time and/or location that the motivation is needed.

### CROSS-REFERENCE TO RELATED APPLICATIONS

This application claims priority from provisional patent application: “Process to promote healthy behaviors through motivation using mobile messaging and geofencing technologies.”

application Ser. No. 61/721,595

Filing date: Nov. 2, 2012

Applicants: Same applicants as this application/specification

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

Individuals want to lead healthier lifestyles but find that lapses in motivation derail their good intentions. They often encounter a time and/or place that triggers a weak moment and a lapse in positive behavior. A comprehensive motivational system helps individuals lead healthier lifestyles, thereby reducing their medical expenses. Through motivation, individuals will maintain positive behaviors when addressing their personal health issues, such as dieting, exercising, stopping drinking, stopping smoking, and reducing stress. Because of the ubiquity of smart phones, a mobile system that offers a process to motivate and support behaviors can lead to these healthier lifestyles. Multiple studies have shown that mobile text motivational systems work for positive behavioral changes. Yet, while these systems exist, they are not highly personalized, only use texts, and are not sensitive or aligned with the time and locations that trigger weak moments and lapses in positive behavior. These are major problems and detriments to these other mobile motivational systems.

### BRIEF SUMMARY OF THE INVENTION

Presented herein, and different from other systems, is a mobile health and wellness motivational system in which users specify times and/or locations where they know they will need help with lifestyle challenges. Using the smartphone's clock and geo-fencing technologies, a motivational message arrives at the specified time and/or location. Highly personalized, this system provides motivation in the form of text, photo, video, music or launched text or call; using inspiration, deterrent, tips or distraction at the specified time or place that the motivation is needed.

### BRIEF DESCRIPTION OF THE SEVERAL VIEWS OF THE DRAWING

FIG. 1—Geo-fenced Mobile Device Creating/Updating an Event on Host Service

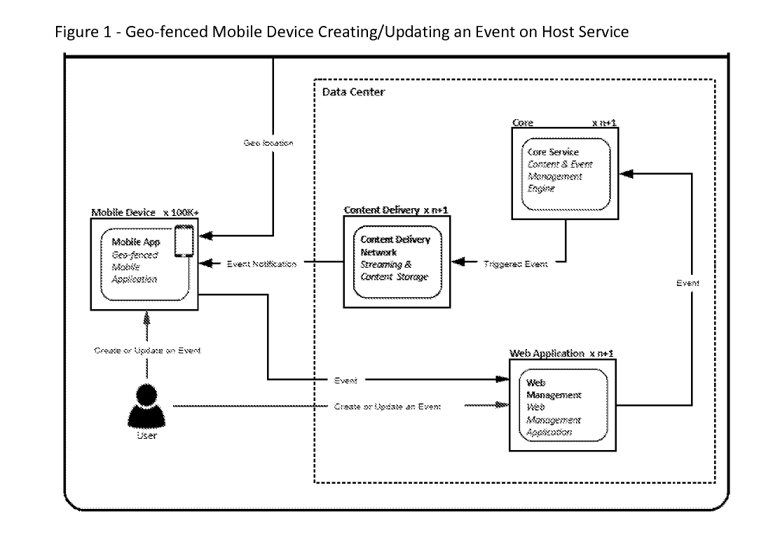

FIG. 2—Geo-fenced Mobile Device Retrieving Event from Host Service

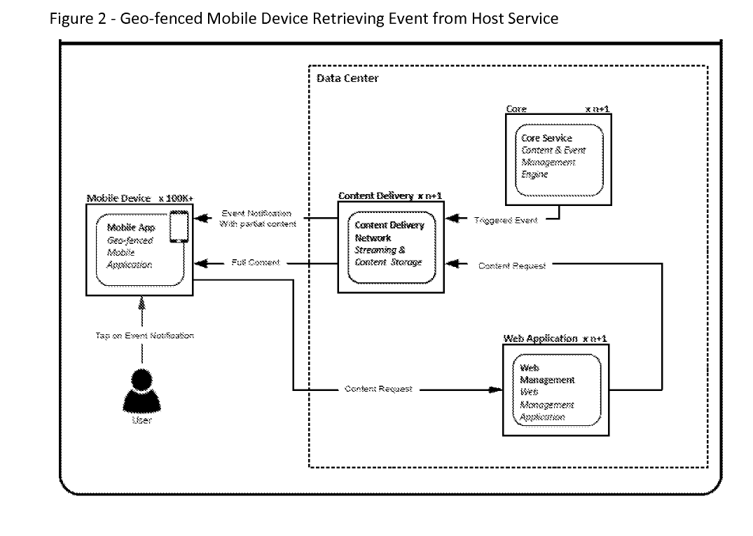

FIG. 3—Geo-fenced Mobile Device Creating Content

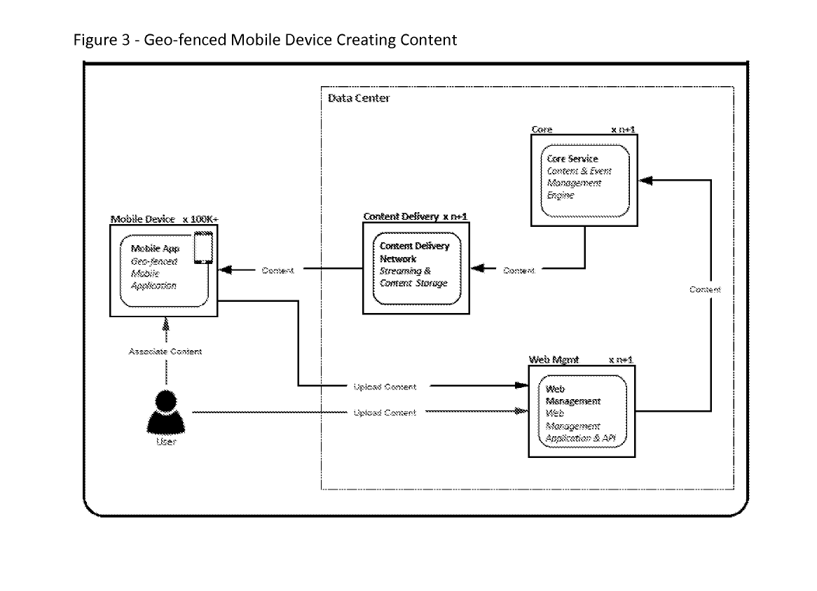

FIG. 4—Geo-fenced Mobile Device Rating Content

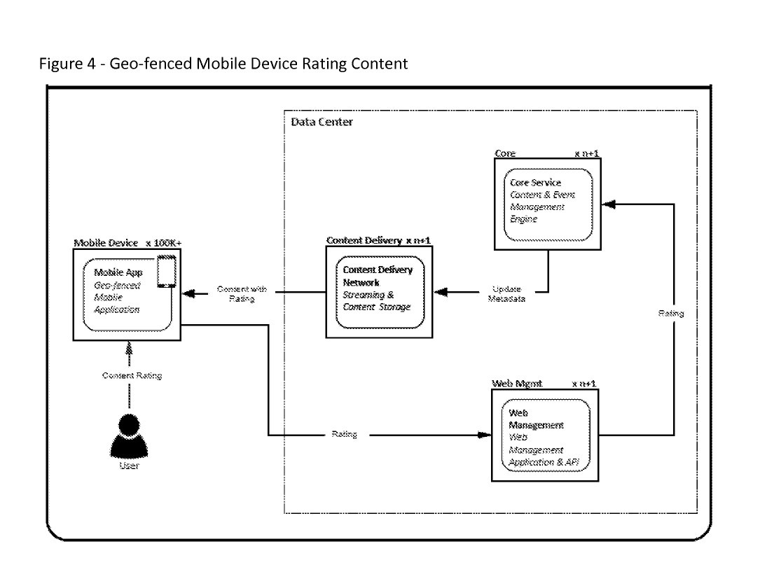

FIG. 5—Geo-fenced Mobile Event and Content Service Technical Architecture

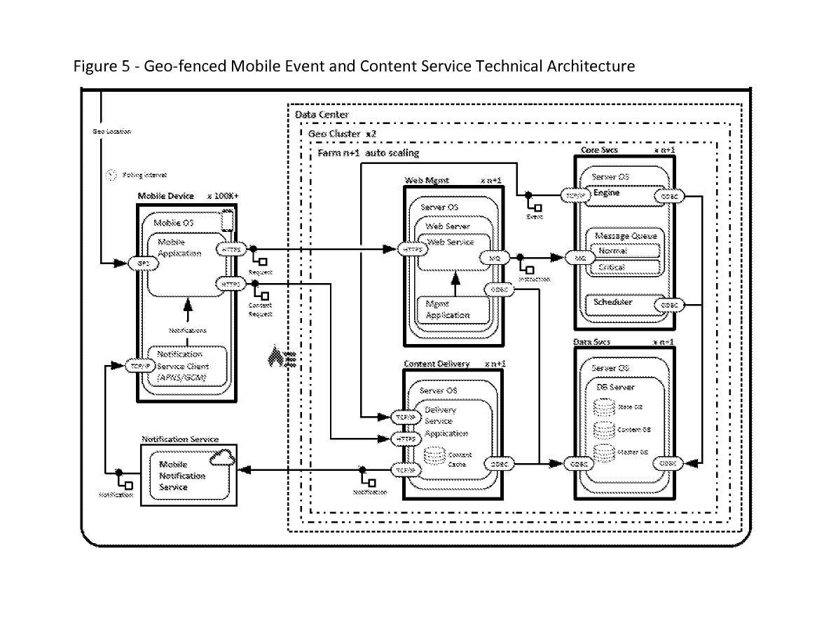

### DETAILED DESCRIPTION OF THE INVENTION

Through positive behaviors, individuals continually address their personal health issues, such as losing weight, exercising more, or stopping drinking, smoking cessation, and stress management. However, they often encounter time and/or place that triggers a weak moment and a lapse in positive behavior. This system sends motivational messages to the user's mobile device at a designated time and/or location, supporting the user's efforts to continue successful behaviors and lead a healthier life.

The user identifies a “moment” (event) in which he knows he will need motivation to continue a positive behavior. The user creates/enters the moment into the system by choosing:

The health area for the moment: diet, exercise, smoking, drinking, stress.

The trigger for the moment: a location (map function opens), time (clock function opens).

The method of motivational messaging for the moment: text, picture, video, music; or a launched text or phone call to another designated individual who can help the user.

The style of message (text, picture, video or music) to be received—an inspiration, deterrent, distraction or advice; the user can also choose to be “surprised” by a system generated style choice.

The source of the message content—the users own/uploaded content, content from the system's library, or “surprised” by a system generated source choice.

The user can enter as many separate moments as needed following the steps above. The user can create moments with the system through his mobile device or a web-based portal, and can edit, change or delete moments as needed. The users own content can be uploaded to his mobile device, where it will stay resident, or the user can upload content to the system library to be used by others, if so desired. The system also provides for setting up “panic button” moments in order to receive motivation when needed if the user is not at a pre-defined location or it is not the pre-defined time.

When the moment is triggered by location (through the user's phone and geo-fencing), time (the phone's clock/alarm function), or by pressing a panic button, the motivational message will be sent to the user's phone; or the user's phone will launch a phone call to the designated individual who can help the user.

After the message has been executed, the user can rate the content.

The system will collect aggregate data on every segment of use—health areas, triggers, methods, styles, locations and content popularity and source.

The system described is unique in the following respects:

Addressing multiple areas simultaneously using multiple “moments” (events).

Using geo-fencing and/or specific times to define triggers.

Offering multiple methods of motivation: text, picture, video, music; or launched text or phone call.

Offering the personally-chosen style of motivational messaging: inspiration, deterrent, distraction or tips.

Offering user-generated or system-generated content.

1. A method to help people maintain positive health and wellness behaviors using a mobile motivational system utilizing smart phone geo-fencing and time functionality.

2. The method of claim 1 further comprising that the user identifies a time and/or location (i.e. an “event”) in which he knows he will need motivation to continue a positive behavior for a health or wellness lifestyle issue.

3. The method of claim 1 further comprising that the user will use his mobile device or a web portal to create a motivational message for the event.

4. The method of claim 1 further comprising that the user decides on the type of motivational message to receive for the event—text, picture, video, music or a launched text or phone call.

5. The method of claim 1 further comprising that the user decides the style of motivational message (text, picture, video or music) to be received—an inspiration, deterrent, distraction or tip.

6. The method of claim 1 further comprising that the user decides the source of the motivational message content—the user's own uploaded content, or content from the system's library.

7. The method of claim 1 further comprising that the user can update, change or delete any of his event choices at his discretion.

8. The method of claim 1 further comprising that the user can create and upload his own motivational message of text, picture, video or music to his mobile device or to the system library.

9. The method of claim 1 further comprising that the mobile motivational system will send the user the message at the event's occurrence (time and/or location) or when the panic button is pressed.

10. The method of claim 1 further comprising that the user can rate content.

11. The method of claim 1 further comprising that the system uses the smart phone's geo-fencing, time functionality and other functions in conjunction with data services, core computing services, web management, content delivery and mobile notification services.

12. The method of claim 1 further comprising that the system will collect aggregate data on every segment of use—health areas, triggers, methods, styles, locations and content popularity and source.
